(19) United States
(12) Patent Application Publication
(10) Pub. No.: US 2003/0152096 A1
(43) Pub. Date: Aug. 14, 2003

(54) Intelligent no packet loss networking

(76) Inventor: Korey Chapman, Barrie (CA)

Correspondence Address: McCarthy Tetrault, Suite 4700, Box 48,, 66 Wellington St. W., Toronto, ON, M5K 1E6, CA

(21) Appl. No.: 10/364,405

(22) Filed: Feb. 12, 2003

Related U.S. Application Data
(60) Provisional application No. 60/355,825, filed on Feb. 13, 2002.

(51) Int. Cl. H04L 12/28; H04J 3/16

(52) U.S. Cl. 370/412; 370/468

(57) ABSTRACT

A method and system for dynamically allocating bandwidth to at least two applications sharing a communication channel of a fixed bandwidth for simultaneous transmission in a communication network. The method includes determining a bandwidth required for optimal transmission of each application, monitoring the flow of packets of each application, determining amount of the allocated bandwidth in use by each application, and assigning an unused portion of the allocated bandwidth of one application to the other application.

### BACKGROUND OF THE INVENTION

1. Field of the Invention

The present invention relates to network bandwidth management, more particularly it relates to a method of bandwidth allocation to traffic sharing a fixed bandwidth.

2. Description of the Prior Art

Transmission control protocol (TCP) provides connection-oriented services for the Internet Protocol's (IP) application layer, that is, the transmitting network entity and the receiving network entity must establish a connection to exchange data. TCP transmits data in segments encapsulated in IP datagrams, along with checksums used to detect data corruption, and sequence numbers to ensure an ordered byte stream. TCP is considered to be a reliable transport mechanism because it requires the receiving network entity to acknowledge not only the receipt of data but its completeness and sequence. Each network entity includes network communication software, which may operate in accordance with the well-known Transport Control Protocol/Internet Protocol (TCP/IP). TCP/IP basically consists of a set of rules defining how entities interact with each other. In particular, TCP/IP defines a series of communication layers, including a transport layer and a network layer. At the transport layer, TCP/IP includes both the User Data Protocol (UDP), which is a connectionless transport protocol, and TCP which is a reliable, connection-oriented transport protocol.

TCP/IP was designed primarily to support two traffic applications, file transfer protocol (FTP) and telnet. However, the integration of traditional analog information services, particularly voice and video, with digital data services such as streaming media, integrated messaging, digital telephony, and video-conferencing have contributed to great strain on the existing network infrastructure. As is well known in the art, packet networks are highly shared data networks that involve some degree of variability and unpredictability in terms of levels of latency and loss. Some applications can tolerate considerable levels of such problems, since there is sufficient time to adjust and recover through retransmission. However, with time-sensitive applications such as VoIP and multimedia, the quality is significantly degraded making it unbearable for the users. In order to support voice and other such multimedia in its native analog form over a digital network, the analog signal is encoded into a digital format, and at the receiving end the digital signal is decoded into the analog format. These conversion processes are accomplished by a matching pair of codecs (coder/decoders), encompassing such standards as H.323, H.263, H.261 and G.xxx series of audio compression.

One of the approaches that has been proposed to overcome these performance issues is the addition of more bandwidth. However, this is a short-term solution since bursty traffic consumes all the available bandwidth at the expense of other applications. Another solution is the use of queuing schemes, such as priority output queuing and custom queuing, which attempt to prioritize and distribute bandwidth to individual data flows. Queuing schemes try to prevent low-volume applications, such as interactive web applications, from getting overtaken by large data transfers, such as FTP traffic. However, such dynamic queuing schemes fail to provide real-time dynamic allocation of bandwidth, since these methods simply give precedence to traffic of high priority while traffic with low priority is buffered until the higher prioritized traffic has been transmitted. Also, this results in buffer overflows in which case packets are lost and the service is degraded.

Another solution is provided by Packeteer's PACKETSHAPER®, from California, U.S.A. The PACKETSHAPER uses TCP rate control to proactively prevent congestion on both inbound and outbound traffic. The TCP rate control scheme rate-limits traffic based on certain matching criteria, such as incoming interface, IP precedence, QoS group, or IP access list criteria. The TCP rate control scheme provides configurable actions, such as transmit, drop, set precedence, or set QoS group, when traffic conforms to or exceeds the rate limit. Also, the implementation of the TCP rate control scheme allows for a smooth, even flow rate that maximizes throughput, and measures network latency, forecasts packet-arrival times, adjusts the flow rate accordingly, and meters acknowledgements to ensure just-in-time delivery of the transmissions. However, this mechanism merely drops packets of one or more of the applications sharing the fixed bandwidth until the network traffic stabilizes.

Another solution that has been proposed is the Resource Reservation Protocol (RSVP) by The Internet Engineering Task Force (IETF). RSVP is an IP based protocol that allows end-stations, such as desktop computers, to request and reserve resources within and across networks. Essentially, RSVP is an end-to-end protocol that defines a means of communicating the desired Quality of Service between routers. While RSVP allows applications to obtain some degree of guaranteed performance, it is a first-come, first-served protocol, which means if there are no other controls within the network, an application using RSVP may reserve and consume resources that could be needed or more effectively used by some other mission-critical application. A further limitation of this approach to resource allocation is the fact that RSVP lacks adequate policy mechanisms for allowing differentiation between various traffic flows.

It is an object of the present invention to mitigate or obviate at least one of the above-noted disadvantages.

### SUMMARY OF THE INVENTION

In accordance with one of its aspects, the invention provides a method of dynamically allocating bandwidth to at least two applications sharing a communication channel of a fixed bandwidth for simultaneous transmission in a communication network, the method having the steps of:

(a) monitoring traffic associated with the applications;

(b) associating each of the applications with a predetermined traffic class, the predetermined traffic class being associated with a set of traffic characteristics;

(c) associating each of the traffic classes with a policy map;

(d) allocating a predetermined amount of bandwidth for an optimal transmission rate to each of the traffic classes;

(e) associating each of the traffic classes with a class of service, the class of service having a value indicative of transmission priority in accordance with the policy map;

(f) routing packets of each application using IP session based packet switching;

(g) allowing any of the at least two applications to use more than the predetermined amount of bandwidth when a portion of said fixed bandwidth is unused;

(h) reducing the bandwidth of any of the at least two applications to the predetermined bandwidth if another application initiates transmission;

(i) storing packets of each traffic class in a queue;

(j) monitoring the packets stored in the queue;

(k) regulating the transmission rate using the queue; and

(l) limiting the transmission rate in accordance with the policy map; whereby the traffic associated with the at least two applications is transmitted and received without traffic loss.

In another aspect of the invention there is provided a system for dynamically allocating bandwidth to at least two applications sharing a communication channel of a fixed bandwidth for simultaneous transmission in a communication network, the system having: a network entity for monitoring traffic including packets associated with the applications and associating each of the applications with a predetermined traffic class, the predetermined traffic class having a set of traffic characteristics and a predetermined quality of service; a switch for forwarding the packets between a source and a destination based on a flow rate of the packets; a queue at the source and at the destination for regulating transmission of the packets therebetween; a set of bandwidth allocation rules defining the allocation of bandwidth when the at least two applications are transmitting simultaneously; the packets are transmitted in a lossless manner between the source and the destination.

Thus, the present invention allocates a predetermined bandwidth size for optimal application transmissions. In addition, it dynamically allocates unused bandwidth to the applications to a maximum of the remainder of network resources when other the applications are not transmitting. In the event other determined application traffic is introduced over the network, the invention will dynamically reassign network resources, ensuring each application operates at better or its predetermined optimal parameters. In addition to each application achieving optimal performance, the forwarding of packets are further optimized when each transmission is routed via IP session based packet switching which continually operates on a per session basis. The key differentiation attribute of this invention is the ability to effectively manage application traffic providing optimal or superior transmission performance without the loss or discarding of packets.

### BRIEF DESCRIPTION OF THE DRAWINGS

These and other features of the preferred embodiments of the invention will become more apparent in the following detailed description in which reference is made to the appended drawings, by way of example only, wherein:

FIG. 1 is a communication system of a preferred embodiment;

FIG. 2a is a flowchart outlining the process for dynamic allocation of bandwidth under variable network conditions;

FIG. 2b is a flowchart outlining the process for dynamic allocation of bandwidth under variable network conditions.

### DESCRIPTION OF THE PREFERRED EMBODIMENTS

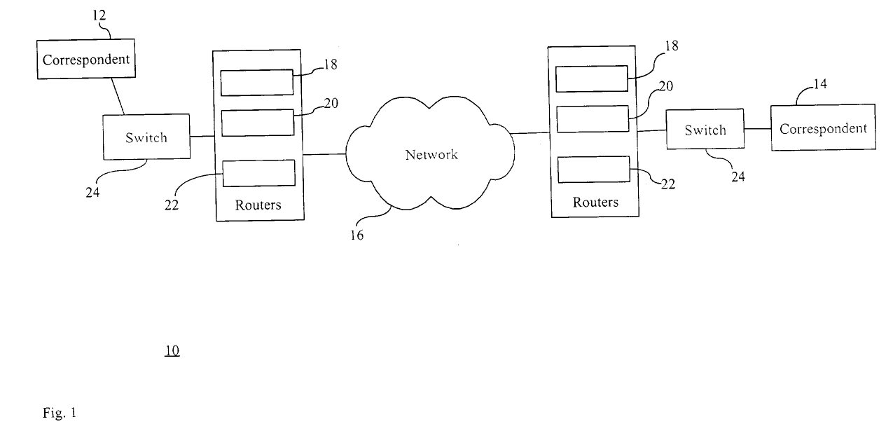

Reference is first made to FIG. 1 showing a communication system shown generally by numeral 10, in a preferred embodiment. The system 10 includes a plurality of network entities, such as a first correspondent 12 communicatively coupled to a second correspondent 14 via a network 16. The network 16 may be any network such as a local area network (LAN), a wide area network (WAN), a metropolitan area network (MAN), a public switched telephone network (PSTN) or a wireless network. Typically, one of the correspondents 12 is a source of video, data or voice traffic. For example, a streaming video server provides streaming video and audio, a session initiated protocol (SIP) server identifies telephone information and routing tables necessary to complete VoIP telephone calls over the network 16, and a file transfer protocol (FTP) server provides data, while a web server provides multimedia content. The other correspondent 14 is a recipient such as a web client, an analog phone with a suitable codec, an IP phone or a client computer. The system 10 also includes a plurality of intermediate network entities such as a core router 18, a customer premises router 20 and a voice gateway router 22 and switches 24 for efficient packet transmission and switching between the correspondents 12 and 14. Thus, the network entities 12,14, 18, 20, 22 and 24 that process digital traffic may comprise a processing unit, and any computer readable medium such as ROM, flash memory, non-volatile RAM, a magnetic disk, an optical disk, an IC memory card or a magnetic tape. Also, such network entities 12, 14, 18, 20, 22 and 24 may include an application program thereon, running on any operating system such as the MICROSOFT® Windows Operating System (OS), LINUX® OS, UNIX® OS or any router OS that supports a conjunction of these standards. Those skilled in the art will appreciate that the present invention may also be implemented on platforms and operating systems other than those mentioned.

The routers 18, 20 and 22 use packet headers and routing information, such as routing tables, and communicate with each other to configure the best route between any two correspondents 12 and 14, whereas the switches 24 filter and forward packets between network 16 segments. The routers 18, 20 and 22 monitor the traffic originating from each network entity 12, 14, 18, 20, 22 and 24 and, by examining IP source and destination addresses, among other information. Generally, the network entity 18, 20 or 22 includes a software module that collects information about itself for use in network management in a management information base (MIB). Typically, the routers 18, 20 and 22 can be managed through the simple network management protocol (SNMP), by making available the information stored in the MIB available to any SNMP-enabled network entity such as router 18, 20 or 22. The use of SNMP allows monitoring and measurement of traffic patterns at the logical interfaces of the router 18, 20 or 22, such as, the number of packets received, packets transmitted, errors, and the like, to generate statistics for any given interface. Also, the network entity 18, 20 or 22 can generate a message or a MIB trap indicating status thereof or an occurrence of an event, such as, when that network entity 18, 20 or 22 is unavailable or down.

The network entities 18, 20 and 22 include at least one policy stored in the computer readable medium thereon. A policy includes executable program instructions for defining how the plurality of packets associated with an application program running on a network entity 12, 14, 18, 20, 22 or 24 are handled within the network 16. Therefore, the network entities 18, 20 and 22 can use the relevant policies to apply to the different traffic flows in the network 16, as described below. The routers 18, 20 and 22 also perform conversion between analog voice signals to VoIP, H.323 conversion, PSTN conversion and SIP conversion to establish voice calls. Therefore, the routers 18, 20 and 22 are configured to access the policies for handling the plurality of traffic types, in order to ensure timely delivery of the traffic without packet loss, especially time-sensitive traffic.

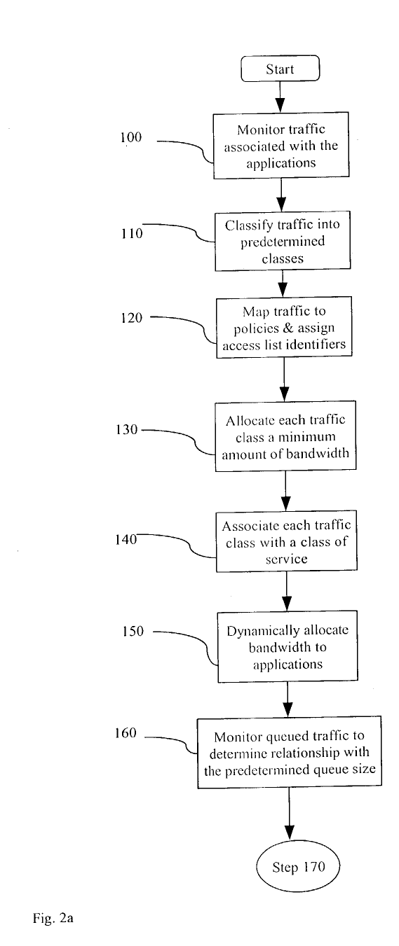

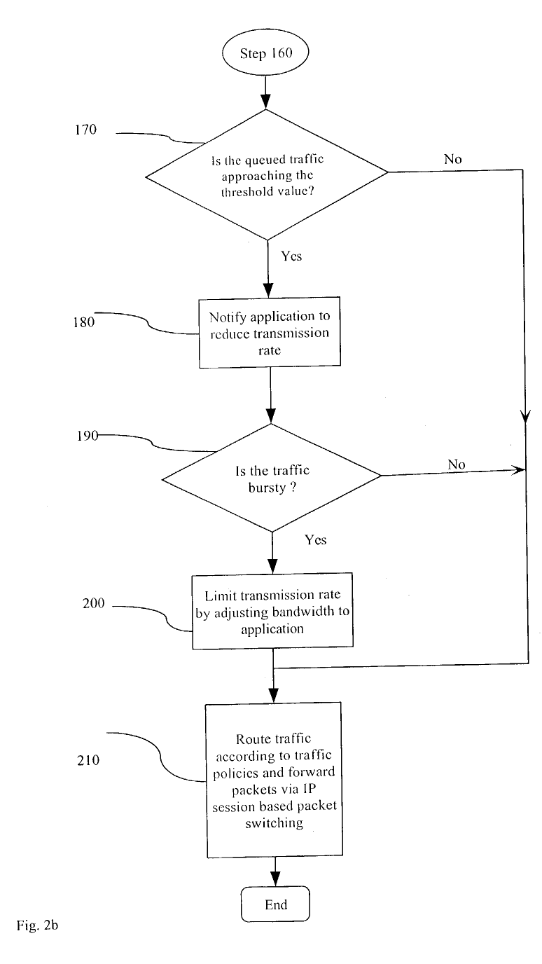

The operation of the system 10 will now be described with reference to the flowchart in FIGS. 2a and 2b. The process starts with step 100, in which the routers 18, 20 and 22 monitor all the traffic within the network 16. All the traffic in the network 16 is classified by matching each traffic flow to one of the predetermined traffic classes to form a traffic classification map, in step 110. The traffic class is based on traffic characteristics such as application type, protocol, traffic type, port number, source and destination.

Each traffic class is then mapped to a policy in step 120, which includes a set of predetermined rules specific to that traffic class. These rules dictate how the traffic class is handled under the variable network 16 conditions. The policies are stored in the computer readable medium on the routers 18, 20 and 22, as described above. In the instance of providing Voice quality, a classification and policy is identified for voice over IP and is assigned a unique access list identifier. Thus, the policy defines a threshold policy for a class, and may include the following parameters: class, bandwidth, fair queuing, weight, and queue limit or random early detection, among others. Thus, each traffic class is queued in a queue of a predetermined size and stored in a buffer based on the source or destination. For example, for video streaming across the network 16, the routers 18, 20 and 22 are configured to buffer multimedia data, for a predetermined amount time and in a predetermined size queue, and utilization of the buffer is monitored by the router 18, 20 or 22.

In step 130, each traffic class is assigned a predetermined amount of bandwidth for an acceptable transmission rate. For example, voice classification is associated with the policy map of “voip”, which provides a predetermined amount of bandwidth of 32 Kbps required for acceptable VoIP transmission. For multimedia applications such as video streaming, the multimedia classification is associated with the policy map of “multimedia”, which provides a predetermined amount of bandwidth of 1000 Kbps required for acceptable multimedia transmission. In step 140, each traffic class is associated with a predetermined class of service. The class of service indicates an IP priority of the traffic classes in the event of network congestion, that is, a hierarchy of transmission in terms of bandwidth for each class. Typically, each IP header includes precedence bits in the type of service (ToS) field to specify a class of service for each packet.

In step 150, the bandwidth is dynamically allocated between the different traffic classes. Using the traffic classification and policies, a percentage of the bandwidth is allocated to each traffic flow, and this particular bandwidth is greater than or equal to the predetermined amount of bandwidth for that application. The predetermined bandwidth assigned to a traffic class is the guaranteed bandwidth delivered to that class in the event of network congestion, as described above. Thus, traffic policies are employed to ensure that if there are other applications transmitting at the same time, and then each application receives its predetermined requirements for bandwidth. However, should there be only one application transmitting at a given time, then that application is assigned the maximum bandwidth of the communication channel.

If another application begins to transmit then that application receives its predetermined amount of bandwidth, while the previous application will receive the difference between the size of the bandwidth and the predetermined bandwidth requirement of the second application. However, should other applications also initiate transmission, then the bandwidth is allocated dynamically between the applications such that each application is guaranteed its predetermined amount of bandwidth. This step is accomplished using a mechanism such as class-based queuing (CBQ), which allows the allocation of specific amounts of bandwidth to the traffic classes. CBQ allows the use of access control lists, protocols or input interface names to define how traffic will be classified.

In step 160, by monitoring the network traffic, the routers 18, 20 and 22, in cooperation with the policies, can anticipate abnormal network conditions. The routers 18, 20 and 22 compile traffic statistics related to the bandwidth use by the different traffic classes. The traffic is analysed over predetermined periods of time for measurements, such as response time, transmission rate, delays and quality of service, are conducted. As mentioned above, the traffic is stored in at least one queue of a predetermined size, and each queue has a threshold level or value associated with the predetermined size and the predetermined bandwidth, the threshold level being less than the predetermined size. Thus, the traffic stored in the queue is monitored to determine the relationship between the queued traffic and the predetermined queue size.

Next, in step 170, a determination is made as to whether the queued traffic is approaching the threshold level of the queue. If it is determined that the queued traffic is not approaching the threshold level then the bandwidth is dynamically allocated to the traffic classes, as described above, and is then forwarded via the IP session based packet switching mechanism to its destination, in step 210. However, if the queued traffic is approaching the threshold level, then there is possibility of network congestion, that is, some traffic classes may suffer packet loss due to diminishing bandwidth resources. In order to detect network congestion a mechanism such as the weighted random early detection (WRED) algorithm is employed. This algorithm allows the ability to distinguish between acceptable temporary traffic bursts and excessive bursts likely to swamp network resources, thus avoiding network congestion. In more detail, the router 18, 20 or 22 detects the possibility of network congestion by computing the average queue size and notifying the application in real-time to reduce the transmission rate before the queued traffic exceeds the threshold level , setting a bit in packet headers, in step 180. The control of the transmission rate is typically implemented using TCP window sizing, as is well known in the art.

In step 190, a determination is made as to whether the traffic is bursty. If the traffic is not bursty, the available bandwidth is dynamically allocated to the traffic classes, as described above, and is then forwarded via the IP session based packet switching mechanism to its destination in step 210. However, if the traffic is bursty, then the transmission rate of any given packet of that bursty traffic is limited by allocating the particular bandwidth to that packet, in step 200. This allocated bandwidth is greater or equal to the predetermined amount of bandwidth allocated to that traffic class. This function of allocating the predetermined bandwidth requirement to the packets depends on the type of policies, the packet's IP address, the application type, precedence, port, or the Media Access Control (MAC) address. Thus, when implemented in conjunction with the WRED mechanism, the function of allocating predetermined bandwidth requirements for the packets keeps the average queue size below the threshold level, while allowing occasional bursts of packets in the queue, such that there is no packet loss.

In step 210, the routers 18, 20 and 22 determine the routing of packets within the network 16 according to the traffic type and routing information. The network entities 12, 14, 18, 20 and 22 are associated with configuration settings comprising classification maps for the traffic types and policy maps, among others. Typically, the customer routers 22 are integrated into the switching architecture using one or multiple high-speed backbone connections. The routers 18, 20 and 22 support a physical and a virtual interface, and these interfaces may be, but are not limited to, FastEthernet, FDDI, Tunnel or Token Ring. The routers 18, 20 and 22, in cooperation with the switches 24 enable the implementation of a virtual LAN. As is well known in the art, a virtual LAN allows the grouping of switch ports and users connected to them into logically defined communities of interest. By grouping ports and users together across multiple switches 24, virtual LANs can span single building infrastructures, interconnected buildings, or even WANs. For example, the traffic classes are assigned a unique virtual LAN associated with a particular port at the switch 24 and at the router 18, 20 or 22, to define a virtual link for each specified traffic class. Each packet in the virtual LAN is identified by placing a unique identifier in the header of the packet as it is forwarded throughout the switch architecture. The identifier is understood and examined by each switch 24 prior to any broadcasts or transmissions to other switches 24, routers 18, 20 and 22. For example, the identifier may be based on the IEEE 802. IQ standard from the Institute of Electrical and Electronic Engineers (IEEE), which is provides a packet-tagging format for identifying packets that belong to particular virtual LANs. When the packet exits the switch architecture, the switch 26 removes the identifier before the packet is transmitted to its destination. Thus, the core router 18 places the traffic into the predetermined traffic classes and performs the function of routing traffic based on packet information and traffic policies, as described above.

The switching of packets improves the forwarding abilities of routing by identifying a flow of packets that are similar in type, source and destination. This provision is supportable in network hardware that supports IP session based packet switching, allowing more efficient traffic forwarding capability, providing more efficient use of resources.

Thus, the system 10 foresees network 16 congestion and controls bandwidth before the bandwidth is completely used. Performance issues are addressed by dynamically allocating bandwidth to time-sensitive applications while assigning predetermined bandwidth to the other applications that are not as time-sensitive. The system 10 thus provides enhanced performance characteristics of the traffic despite less bandwidth resources and without suffering any packet loss, hence relieving the requirement for additional bandwidth.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method of dynamically allocating bandwidth to at least two applications sharing a communication channel of a fixed bandwidth for simultaneous transmission in a communication network, the method having the steps of:
(a) monitoring traffic associated with said at least two applications;
(b) associating each of said at least two applications with a predetermined traffic class, said predetermined traffic class being associated with a set of traffic characteristics;
(c) associating each of said traffic classes with a policy map;
(d) allocating a predetermined amount of bandwidth for an optimal transmission rate to each of said traffic classes;
(e) associating each of said traffic classes with a class of service, said class of service having a value indicative of transmission priority in accordance with said policy map;
(f) routing packets of said at least two applications using IP session based packet switching;
(g) allowing any of said at least two applications to use more than said predetermined amount of bandwidth when a portion of said fixed bandwidth is unused;
(h) reducing said bandwidth of any of said at least two applications to said predetermined bandwidth if another application initiates transmission;
(i) storing packets of each traffic class in a queue;
(j) monitoring said packets stored in said queue;
(k) regulating said transmission rate using said queue; and
(l) limiting said transmission rate in accordance with said policy map; whereby said traffic associated with said at least two applications is transmitted and received without traffic loss.

2. The method of claim 1 wherein said step of regulating said transmission rate includes a further step of notifying any of said at least two applications to reduce said transmission rate in order to maintain said queued packets below a threshold level of said queue.

3. The method of claim 2 wherein network congestion is foreseen and avoided by maintaining said queued packets below said threshold level.

4. The method of claim 1 wherein said step of routing of said packets includes a step of identifying a flow of packets that are similar in type, source and destination.

5. The method of claim 1 wherein said policy map includes executable program instructions on a computer readable medium.

6. The method of claim 1 wherein the step of monitoring said traffic includes the further steps of:
(a) monitoring flow of said packets of each of said at least two applications;
(b) analyzing traffic characteristics is said network to determine the number of packets belonging to each of said at least two applications;
(c) determining a portion of said allocated bandwidth in use by each of said at least two applications; and
(d) assigning an unused portion of said allocated bandwidth of one of each of said at least two applications to another of each of said at least two applications.

7. A method of managing a flow of traffic from a plurality of applications transmitting in a communication network, said method including the steps of:
(a) assigning said traffic to a plurality of traffic classes;
(b) determining a quality of service for each of said traffic classes, said quality of service defining a set of rules for optimal transmission for each of said traffic classes;
(c) monitoring said traffic belonging to each of said traffic classes; and
(d) adjusting in real-time said flow of traffic associated and adhering to said set of rules under any condition of said communication network; whereby said traffic is transmitted and received without traffic loss.

8. The method of claim 7 whereby the step of monitoring said network traffic includes a further step of determining bursty traffic.

9. The method of claim 7 wherein an application associated with said bursty traffic is instructed to substantially diminish transmitting traffic for a predetermined time, such that said bursty traffic is regulated and transmitted without traffic loss.

10. A system for dynamically allocating bandwidth to at least two applications sharing a communication channel of a fixed bandwidth for simultaneous transmission in a communication network, the system having:
(a) a network entity for monitoring traffic including packets associated with said applications and associating each of said applications with a predetermined traffic class, said predetermined traffic class having a set of traffic characteristics and a predetermined quality of service;
(b) a switch for forwarding said packets between a source and a destination based on a flow rate of said packets;
(c) a queue at said source and at said destination for regulating transmission of said packets therebetween; and
(d) a set of bandwidth allocation rules defining said allocation of bandwidth when said at least two applications are transmitting simultaneously; wherein said packets are transmitted in a lossless manner between said source and said destination.

11. The system of claim 10 said quality of service defines a predetermined amount of bandwidth for optimal transmission of packets of said traffic.

12. The system of claim 11 wherein one of said applications can use more than said predetermined amount of bandwidth when a remainder of said fixed bandwidth is available.

13. The system of claim 12 wherein if another application initiates transmission then said one application reduces said bandwidth to said predetermined amount of bandwidth, such that said each of said applications are allocated their predetermined amount of bandwidth respectively.

14. The system of claim 10 wherein said queue is of a predetermined size and includes a threshold level associated with said predetermined bandwidth; said threshold level being less than said predetermined size.

15. The system of claim 14 wherein said queue includes a trigger when said queue size is substantially close to said a threshold level.

16. The system of claim 15 wherein said trigger includes an algorithm to distinguish between temporary traffic bursts and non-temporary traffic bursts likely to swamp network resources.

17. The system of claim 16 wherein said trigger notifies in real-time said application to reduce said packet transmission rate before queued packets exceeds said threshold level, such that network congestion is foreseen and avoided and said packets are transmitted and received in a lossless manner between said source and said destination.

18. The system of claim 10 wherein said switch identifies flows of packets that are similar in type, source and/or destination, and forwards said flows in a predetermined manner.

19. The system of claim 10 wherein said set of bandwidth allocation rules include executable program instructions on a computer readable medium.
